(19) United States
(12) Patent Application Publication
(10) Pub. No.: US 2014/0102415 A1
(43) Pub. Date: Apr. 17, 2014

(54) FUEL SYSTEM AND METHODS

(71) Applicant: Intellectual Property Holdings, LLC, Cleveland, OH (US)

(72) Inventors: Michael Wyban, Euclid, OH (US); Jim Heinz, Madison, OH (US); Ryan Davis, Draper, UT (US); Bradley Trembath, Shaker Heights, OH (US)

(73) Assignee: Intellectual Property Holdings, LLC, Cleveland, OH (US)

(21) Appl. No.: 14/051,977

(22) Filed: Oct. 11, 2013

Related U.S. Application Data
(60) Provisional application No. 61/712,635, filed on Oct. 11, 2012.

(51) Int. Cl. F02M 41/16

(52) U.S. Cl. CPC F02M 41/16
USPC 123/456; 29/890.1

(57) ABSTRACT

The present application discloses an engine, a fuel system for an engine, and a method of installing the fuel system and converting an engine to operate using a second fuel. In one exemplary embodiment, the fuel system comprises at least one fuel rail for the second fuel, at least one connector attached to the fuel rail and configured to fluidly connect the fuel rail to a second fuel injector, and at least one fuel injector adapter configured to receive a discharge end of the second fuel injector and position the discharge end in fluid communication with at least one of an intake port and a combustion chamber of the engine. The fuel system is configured such that the engine operates using the second fuel without removal or use of the original fuel rails and original fuel injectors.

### CROSS REFERENCE TO RELATED APPLICATION

This application is a U.S. Non-Provisional Patent Application which claims priority to U.S. Provisional Patent Application No. 61/712,635, filed on Oct. 11, 2012 and titled “Fuel System and Methods,” which is hereby incorporated by reference in its entirety.

### BACKGROUND

Gasoline fuel injectors for an internal combustion engine are generally mounted in the intake port of the engine. The fuel injector injects gasoline into the intake port where the gasoline is mixed with air. The resulting mixture is then delivered to a combustion chamber of one or more cylinders of the engine. The gasoline injectors are often connected to fuel rails that supply gasoline to the injectors. Gasoline engines may be converted to operate using compressed natural gas (“CNG”).

### SUMMARY

The present application discloses an engine, a fuel system for an engine, and a method of installing the fuel system and converting an engine to operate using a second fuel, such as compressed natural gas (CNG).

In one exemplary embodiment, a fuel system for an engine configured to operate using a second fuel is disclosed. The fuel system comprises at least one fuel rail for the second fuel, at least one connector attached to the fuel rail and configured to fluidly connect the fuel rail to a second fuel injector, and at least one fuel injector adapter configured to receive a discharge end of the second fuel injector and position the discharge end in fluid communication with at least one of an intake port and a combustion chamber of the engine. The fuel system is configured such that the engine operates using the second fuel without removal of the original fuel rails and the original fuel injectors of the engine. In certain embodiments, the fuel system comprises first and second fuel rails for a second fuel, a fuel line connecting the first and second fuel rails, a plurality of connectors attached to the first and second fuel rails, and a plurality of fuel injector adapters. The fuel system is configured such that the engine operates using the second fuel without use of the original fuel rails and original fuel injectors of the engine. Further, the original fuel rails and the original fuel injectors remain in their original location after the fuel system is installed on the engine.

In one exemplary embodiment, a method of converting an engine to operate using a second fuel is disclosed. The method comprises drilling and tapping at least one hole in a lower intake manifold of the engine. The hole extends through the lower intake manifold and fluidly communicates with at least one of an intake port and a combustion chamber of the engine. A fuel injector adapter is installed in the hole. The fuel injector adapter comprises a threaded stem configured to mate with the hole. A second fuel injector is inserted into the fuel injector adapter. The discharge end of the second fuel injector is inserted into a fuel injector opening of the fuel injector adapter. The second fuel injector is connected to a fuel rail. The fuel rail comprises a connector having a cup shaped body portion with an open end for removably attaching the connector to the second fuel injector. The fuel rail is secured to the engine. The original fuel rails and the original fuel injectors are installed in their original location on the intake manifold of the engine. In certain embodiments, the method comprises removing the intake manifold of the engine from the vehicle and placing the intake manifold into a machine that is pre-programmed to drill and tap the hole.

In one exemplary embodiment, an engine configured to operate using a second fuel is disclosed. The engine comprises an intake manifold, original fuel rails, and a plurality of original fuel injectors fluidly connected to the original fuel rails to deliver an original fuel to the engine. Further, the engine comprises first and second fuel rails for a second fuel, a fuel line connecting the first and second fuel rails, a plurality of second fuel injectors fluidly connected to the first and second fuel rails to deliver a second fuel to the engine, a plurality of connectors attached to the first and second fuel rails, and a plurality of fuel injector adapters. Each connector is configured to fluidly connect the fuel rail to a second fuel injector. Each fuel injector adapter is configured to receive a discharge end of a second fuel injector and position the discharge end in fluid communication with at least one of an intake port and a combustion chamber of the engine. The engine operates using the second fuel without removal of the original fuel rails and the original fuel injectors and without use of the original fuel rails and original fuel injectors. The original fuel rails and the original fuel injectors remain in their original location after the first and second fuel rails, second fuel injectors, connectors, and fuel injector adapters are installed on the engine.

These and additional embodiments will become apparent in the course of the following detailed description.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to example the principles of the inventions.

FIGS. 1A-1C are front perspective, rear perspective, and top plan views, respectively, of a fuel system according to an embodiment of the present application.

FIGS. 2A and 2B are exploded perspective views of fuel rails according to an embodiment of the present application.

FIG. 3A are perspective, side, end, and top views, respectively, of a fuel rail according to an embodiment of the present application.

FIG. 3B are top, perspective, side, and cross sectional views, respectively, of a fuel injector connector according to an embodiment of the present application.

FIG. 4A is a perspective view of a fuel system and an intake manifold of an engine according to an embodiment of the present application.

FIG. 4B are side and top views, respectively, of a fuel injector adapter according to an embodiment of the present application.

FIGS. 5A-5E are perspective views illustrating the installation of a fuel system according to an embodiment of the present application.

### DETAILED DESCRIPTION OF EMBODIMENTS

The present application discloses an engine, a fuel system for an engine, a method of installing a fuel system, and a method of converting an engine to operate using a second fuel, such as compressed natural gas (CNG). The fuel system of the present application is generally configured as a secondary fuel system for delivering a second fuel to an intake port of the engine. However, the fuel system of the present application may also be used as the primary fuel system for an engine.

In certain embodiments described herein, the fuel system of the present application is described as being used to convert a gasoline engine to operate using a second fuel. However, it should be understood, that the fuel system of the present application may be used to convert various engine types configured to operate using various types of fuel. For example, the fuel system of the present application may be used to convert engines configured to operate using gasoline, diesel, propane, ethanol, or the like.

Further, in certain embodiments, the fuel system of the present application is described as converting an engine to operate using an alternative fuel such as CNG. However, it should be understood, that the fuel system of the present application may be used to convert an engine to operate using various types of fuel. For example, the fuel system of the present application may be used to convert an engine to operate using CNG, Liquid Natural Gas (LNG), Liquid Petroleum Gas (LPG), Hydrogen, Hythane, Butane, or other gaseous fuels and mixtures thereof.

The fuel system of the present application generally comprises one or more fuel rails and a fuel line connecting the fuel rails. The fuel rails may comprise one or more connectors configured to removably attach the fuel rails to one or more fuel injectors. The fuel system may also comprise one or more fuel injector adapters configured to receive the discharge end of the fuel injectors and position the discharge end in fluid communication with an intake port of the engine. The fuel injectors inject fuel into the intake port where the fuel is mixed with air. The resulting mixture is then delivered to the combustion chamber of the engine cylinders. In certain embodiments, however, the fuel injector adapters may be configured to position the discharge end of the fuel injector in direct fluid communication with the combustion chamber.

The fuel system of the present application facilitates conversion of the engine to operate using a second fuel without connecting to the existing fuel rails or fuel injectors of the engine (i.e., the original fuel rail(s) and original fuel injectors of the engine, e.g., prior to installation of the fuel system of the present application). The existing fuel rails and fuel injectors remain in their original location after the fuel system is installed and the engine is converted to operate using the second fuel. Further, because the fuel system of the present application facilitates conversion of the engine to operate using a second fuel without removal of the original fuel rails or fuel injectors (e.g., the gasoline fuel injectors) of the engine, the engine may be configured to selectively operate using the original fuel (e.g., gasoline) and/or the second fuel (e.g., CNG). The original fuel injectors are undisturbed and remain in their original location after the engine is converted to operate using the second fuel.

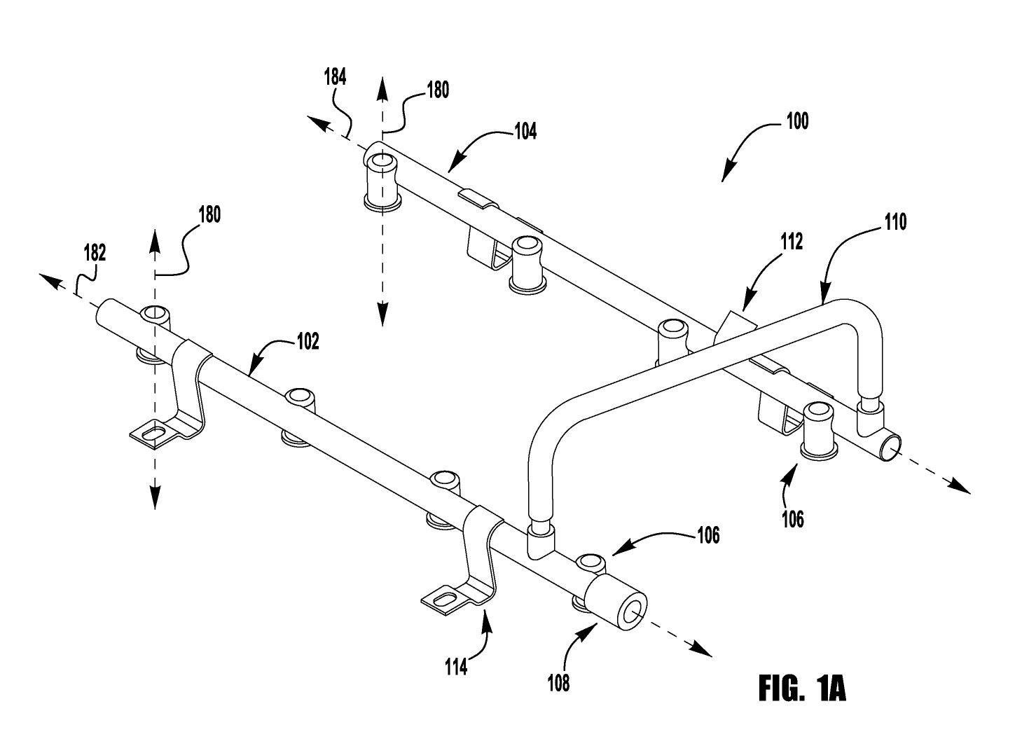

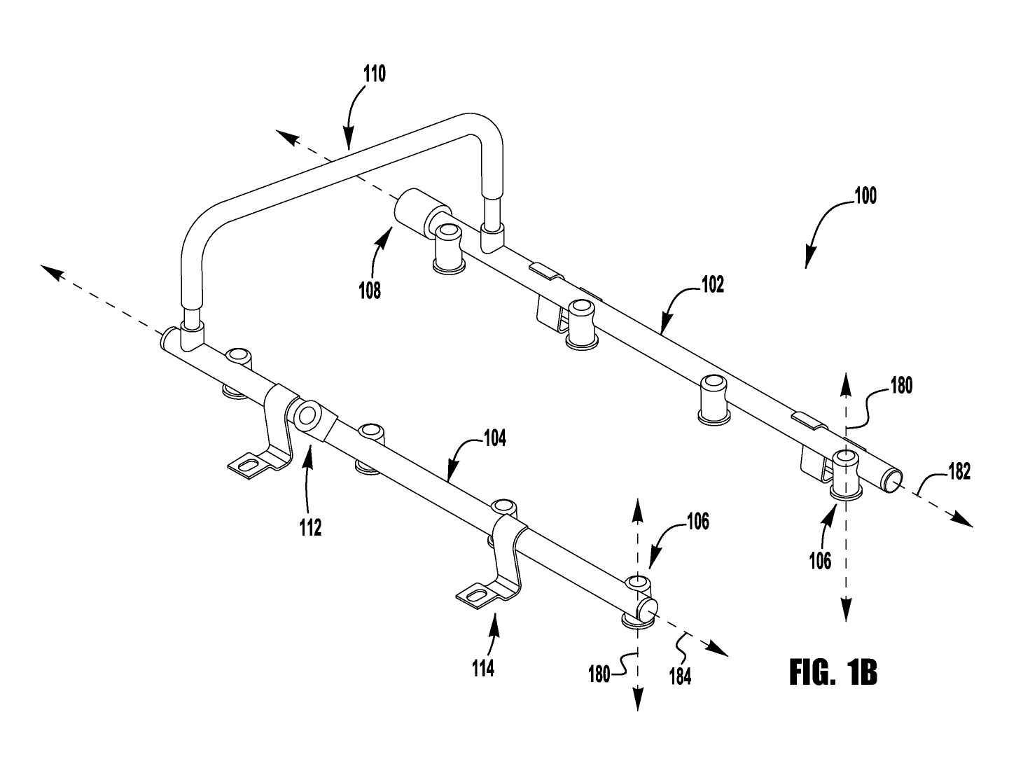

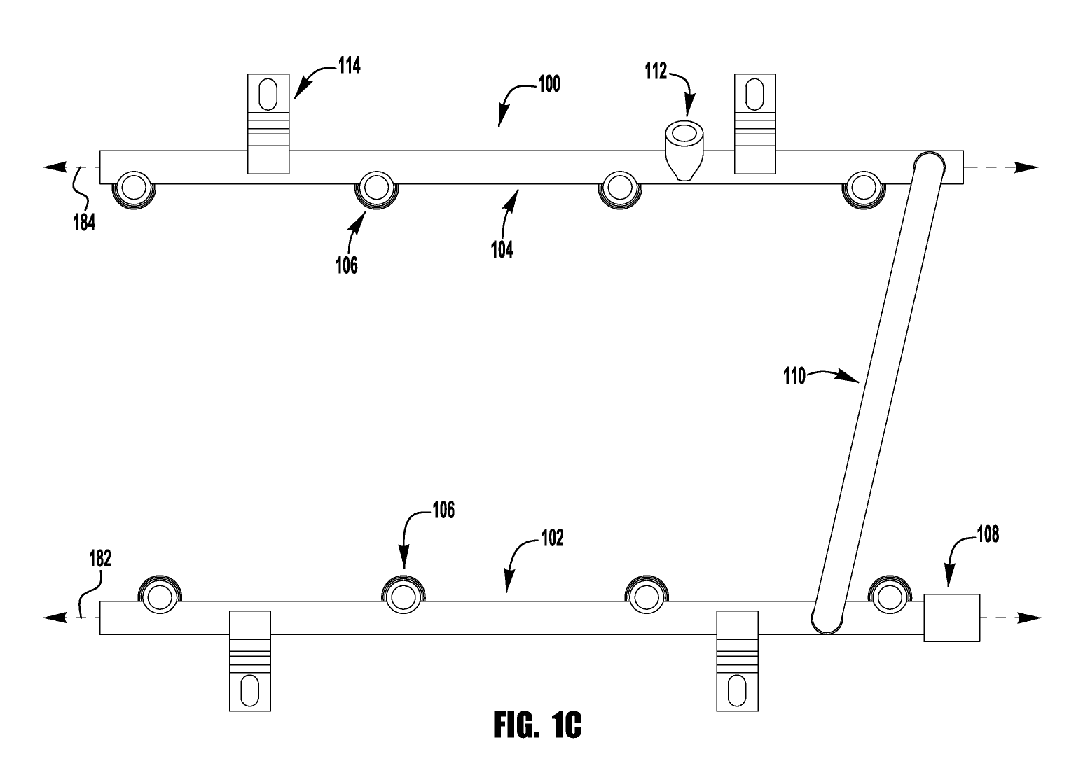

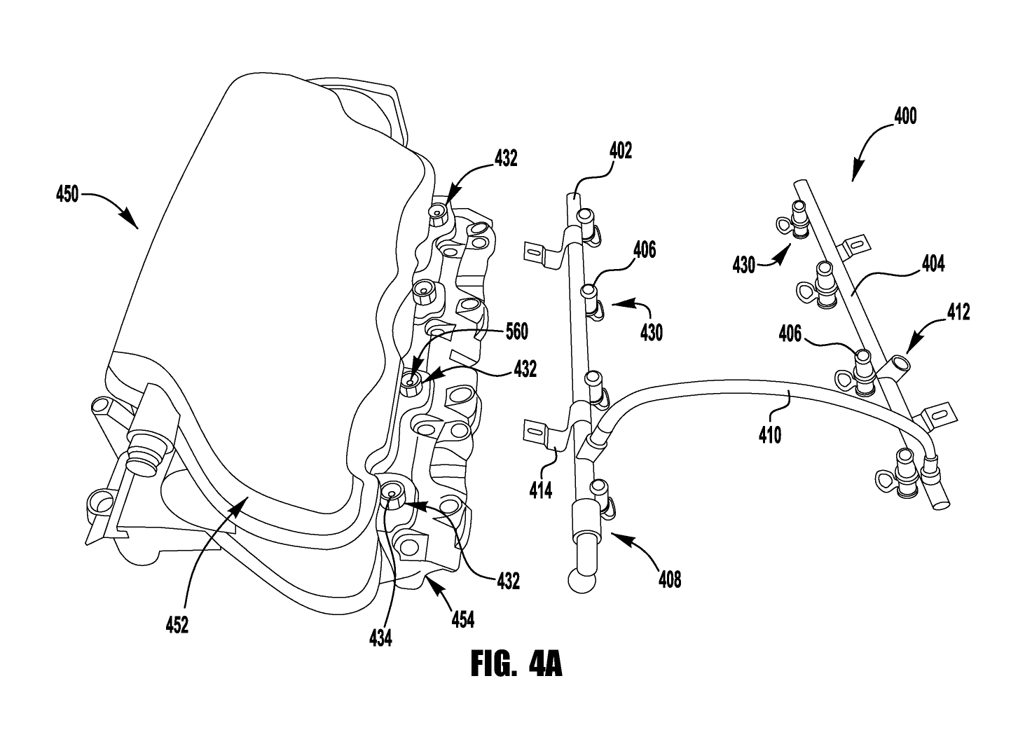

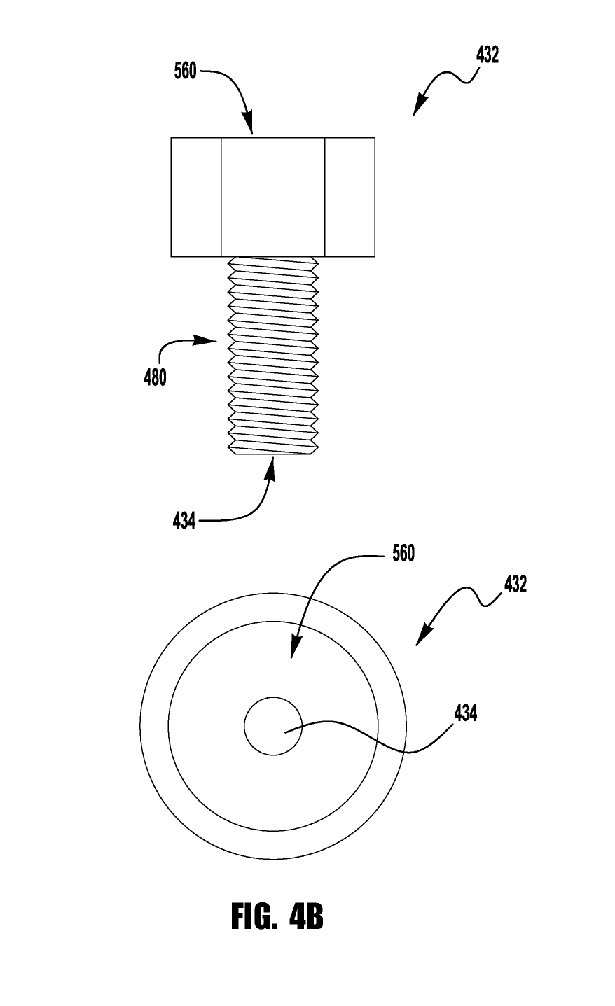

FIGS. 1A-1C illustrate various views of a fuel system 100 according to an embodiment of the present application. As shown, the fuel system 100 comprises a first fuel rail 102, a second fuel rail 104, a fuel line 110 attaching the first and second fuel rails, a plurality of fuel injector connectors 106, a plurality of fuel injectors, and a plurality of fuel injector adapters. The fuel injectors and fuel injector adapters are not shown in FIGS. 1A-1C, but are shown in FIG. 4 as part of the fuel system 400 and are described below.

As illustrated in FIGS. 1A-1C, the fuel system 100 is configured for use with an eight cylinder engine. Each fuel rail 102 and 104 of the fuel system 100 comprises four fuel injector connectors 106 for fluidly connecting the fuel rail to four corresponding fuel injectors, one for each cylinder of the engine. However, it should be understood that the fuel system of the present application may be configured for use with a variety of engines having any number of cylinders, such as, for example, four, six, eight, ten, or twelve cylinder engines.

As illustrated in FIGS. 1A-1C, the first and second fuel rails 102 and 104 comprise an elongated member that is configured to deliver fuel to the one or more fuel injectors of the fuel system 100. The first and second fuel rails 102 and 104 may be configured as a single unitary component or formed from a combination of components. Further, the first and second fuel rails 102 and 104 may be made from a variety of materials, such as, for example, plastic, liquid photopolymers, ferrous materials such as steel or stainless steel, or non-ferrous materials such as aluminum. In certain embodiments, the first and second fuel rails 102 and 104 are made from stainless steel.

The first and second fuel rails 102 and 104 may comprise a variety of cross sectional shapes, including, for example, circular, square, rectangular, oval, triangular, hexagonal, or other shapes. In certain embodiments, the cross sectional shape and size of the first and second fuel rails 102 and 104 may vary along the length of the rail. As illustrated in FIGS. 1A-1C, the first and second fuel rails 102 and 104 have a circular cross section along the entire length of the cylindrical rail. The first and second fuel rails 102 and 104 generally have an interior diameter between about 0.25 inch and about 0.5 inch and an overall length between about 12 inches and about 25 inches. In certain embodiments, the first and second fuel rails 102 and 104 have an interior diameter of about ⅜ inch and an overall length of about 15 inches (e.g., 15.3 inches in some embodiments). This interior diameter of the first and second fuel rails 102 and 104 provides an adequate flow of fuel, such as CNG, through the rails and to the fuel injectors of the fuel system 100.

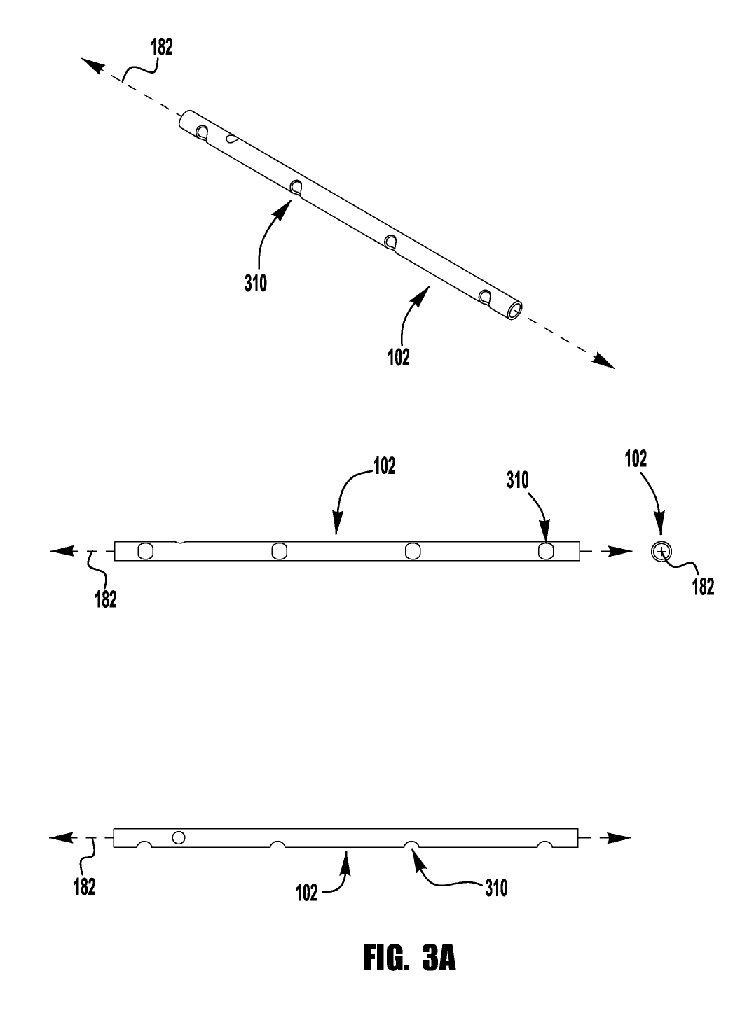

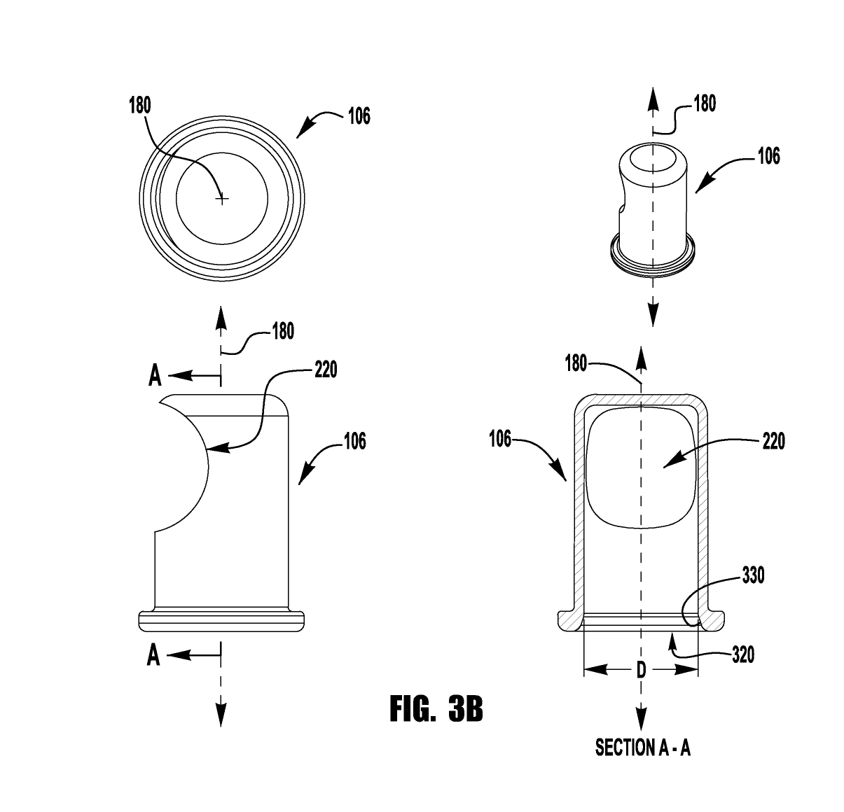

As illustrated in FIG. 3A, the first and second fuel rails 102 and 104 have a series of openings 310 along the length of the rail. Although only the first fuel rail 102 is shown in FIG. 3A, the second fuel rail 104 also comprises the openings 310 along the length of the rail. The openings 310 are configured to mate with corresponding openings 220 in the fuel injector connectors 106 of the fuel system 100. As shown in FIG. 3A, the openings 310 in the fuel rail 102 are formed by U-shaped notches in the fuel rail that are spaced along the length of the fuel rail to correspond to the locations of the fuel injectors. The openings 310 in the fuel rails 102 and 104 may have a radius between about 0.125 inch and about 0.375 inch. In one embodiment, the openings 310 have a radius of about ¼ inch.

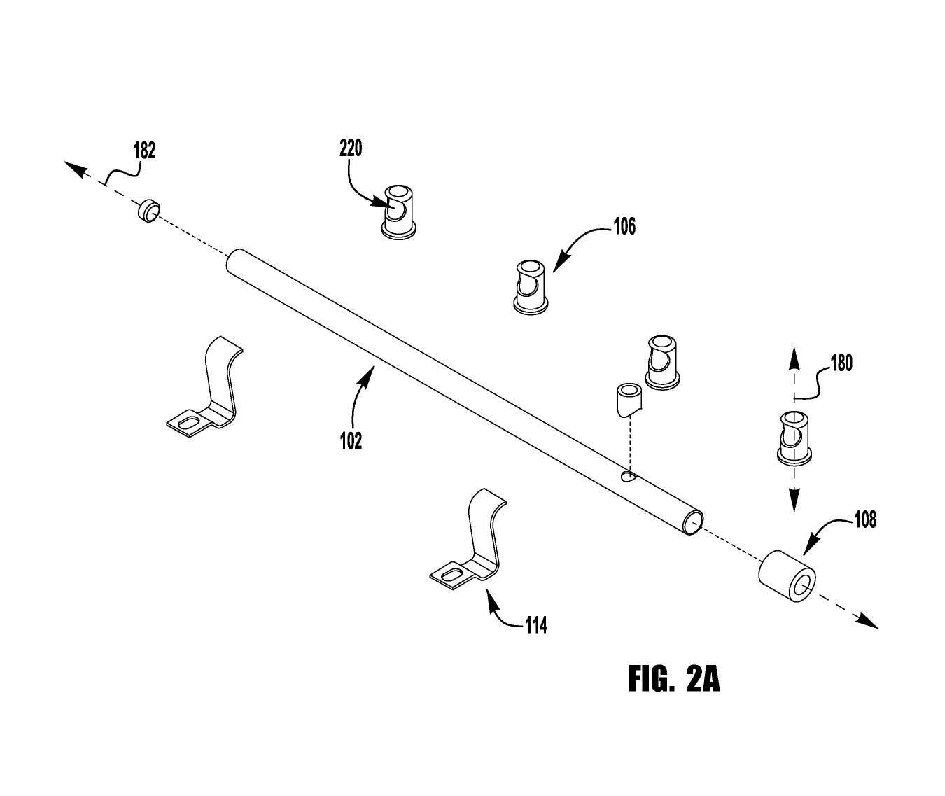

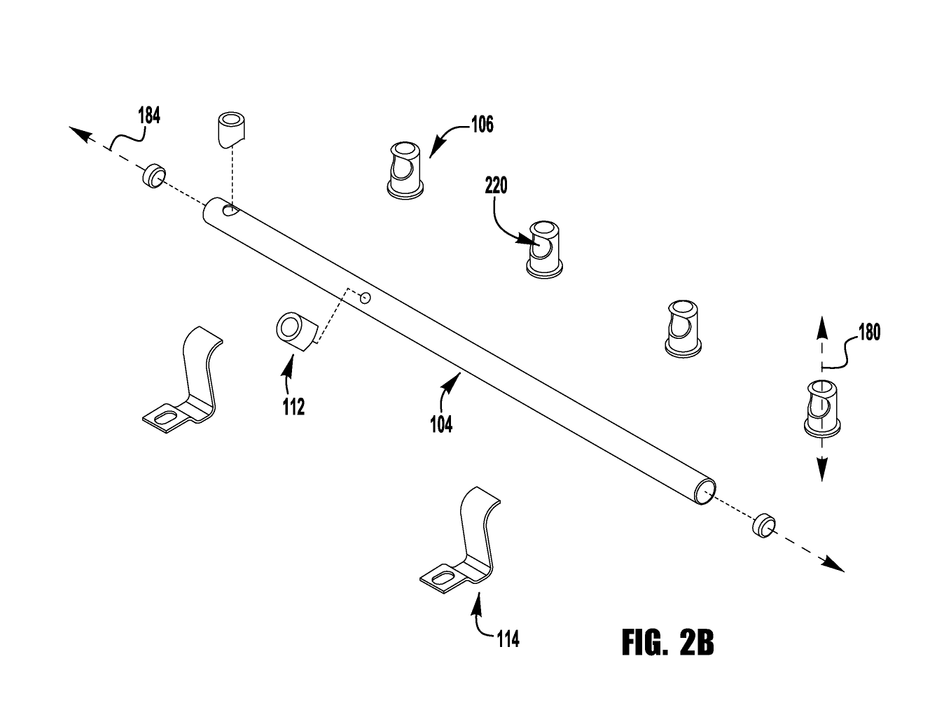

As illustrated in FIGS. 2A-2B and 3B, the connectors 106 of the fuel system 100 comprise an opening 220 that is configured to mate with the openings 310 in the fuel rails 102 and 104. As shown in FIG. 3B, the opening 220 in the connector 106 is formed by a U-shaped notch in the body of the connector. The openings 220 of the connectors 106 may have a radius between about 0.25 inch and about 0.5 inch. In one embodiment, the openings 220 have a radius of about 0.3 inch. The openings 310 in the fuel rails 102 and 104 and the openings 220 in the connectors 106 of the fuel system 100 are sized and configured prohibit turbulent flow of fuel, such as CNG, to the fuel injectors when the connectors are attached to the fuel rails.

As shown in FIGS. 1A-1C, the connectors 106 are attached to the fuel rails 102 and 104 such that the opening 220 in the connector mates with or surrounds the corresponding opening 310 in the fuel rail. As shown, the longitudinal axis 180 of the connectors 106 are substantially perpendicular to the longitudinal axes 182 and 184 of the fuel rails 102 and 104 when the connectors are attached to the fuel rails. As such, the connectors 106 are positioned for attachment to fuel injectors mounted in the lower intake of the engine. However, the connectors 106 may be attached to the fuel rails 102 and 104 at a variety of different angles to facilitate connection of the fuel rails to fuel injectors of the engine. For example, the angle between the longitudinal axis 180 of one or more of the connectors 106 and the longitudinal axes 182 and 184 of the fuel rails 102 and 104 may be between 0° and 90°, 45° and 90°, 60° and 90°, or any other angle needed to connect the connectors and the fuel injectors. The connectors 106 may be attached to the fuel rails 102 and 104 in a variety of ways, such as, for example, by brazing, soldering, or welding the components together or attaching the components by use of an adhesive, fastener, threaded connection, or other means. In one embodiment, the connectors 106 and the fuel rails 102 and 104 are made of stainless steel and are brazed together to form a rigid and fluid tight structure.

As illustrated in FIGS. 1A-2B and 3B, the connectors 106 comprise a cup or cap shaped body portion having an open end 320 for attaching the connector to a fuel injector of the fuel system 100. The open end 320 is sized and configured to receive the supply or receiving end of the fuel injector such that the connector 106 snaps onto the fuel injector. The connection between the connector 106 and the fuel injector is substantially fluid tight. A seal, such as a molded rubber gasket, may be used to seal the connection between the connector 106 and the fuel injector. Other methods may be used to seal the connector 106 with the fuel injector, such as, for example, by using room temperature vulcanized (RTV) rubber, organic paper gaskets, or ferrous gasket materials.

As illustrated in FIG. 3B, the open end 320 of the connector 106 comprises an angled wall 330 forming a chamfered opening to facilitate attachment to the supply or receiving end of the fuel injector. Further, the diameter D of the open end 320 is generally between about 0.25 inch and about 0.75 inch. In one embodiment, the diameter D of the open end 320 is about 0.5 inch. The connectors 106 of the fuel system 100 may be made from a variety of materials, such as, for example, plastic, liquid photopolymers, ferrous materials such as steel or stainless steel, or non-ferrous materials such as aluminum. In certain embodiments, the connectors 106 are made from stainless steel.

As illustrated in FIGS. 1A-1C, the fuel line 110 of the fuel system 100 extends upward from the first fuel rail 102 and then over and downward to the second fuel rail 104. Fuel from a remote fuel source (not shown) is delivered to the first fuel rail 102 at the fuel connection point 108. The fuel received by the first fuel rail 102 is distributed to the second fuel rail 104 by the fuel line 110 that fluidly connects the first fuel rail to the second fuel rail. As will be discussed in greater detail below, the fuel line 110 may be flexible to facilitate installation of the first and second fuel rails 102 and 104 on opposing sides of the engine. Also, the fuel line 110 is sized and configured to extend over the upper intake manifold of the engine when the fuel system 100 is installed.

The fuel line 110 may be connected to the first and second fuel rails 102 and 104 in a variety of ways. For example, the fuel line 110 may be attached to the first and second fuel rails 102 and 104 with a connector, such as a threaded connector, that forms a substantially fluid tight connection between the fuel line and the fuel rails. Further, the fuel line 110 may be attached to the first and second fuel rails 102 and 104 by brazing, soldering, or welding the components together or attaching the components by use of an adhesive, fastener, connector, clamp, or other means. The fuel line 110 of the fuel system 100 may be made from a variety of materials, such as, for example, plastic, rubber, liquid photopolymers, ferrous materials such as steel or stainless steel, or non-ferrous materials such as aluminum. In certain embodiments, the fuel line 110 is a flexible, braided stainless steel line having connectors for fluidly connecting the fuel line to the first and second fuel rails 102 and 104.

One or more of the fuel rails of the fuel system 100 may comprise a pressure sensor to monitor the pressure of the fuel in the fuel system. As illustrated in FIGS. 1A-2B, the second fuel rail 104 comprises a port 112 for a pressure sensor. Further, as shown, the first and second fuel rails 102 and 104 comprise brackets 114 for mounting the fuel rails to the engine. The brackets 114 may be attached to the first and second fuel rails 102 and 104 in a variety of ways, such as, for example, by brazing, soldering, or welding the components together or attaching the components by use of an adhesive, fastener, connector, clamp, or other means.

FIG. 4A shows a fuel system 400 and the intake manifold 450 of an engine according to an embodiment of the present application. As shown, the fuel system 400 comprises a first fuel rail 402, a second fuel rail 404, a flexible fuel line 410 attaching the first and second fuel rails, a plurality of fuel injector connectors 406, a plurality of fuel injectors 430, and a plurality of fuel injector adapters 432. The intake manifold 450 comprises an upper intake manifold 452 and a lower intake manifold 454.

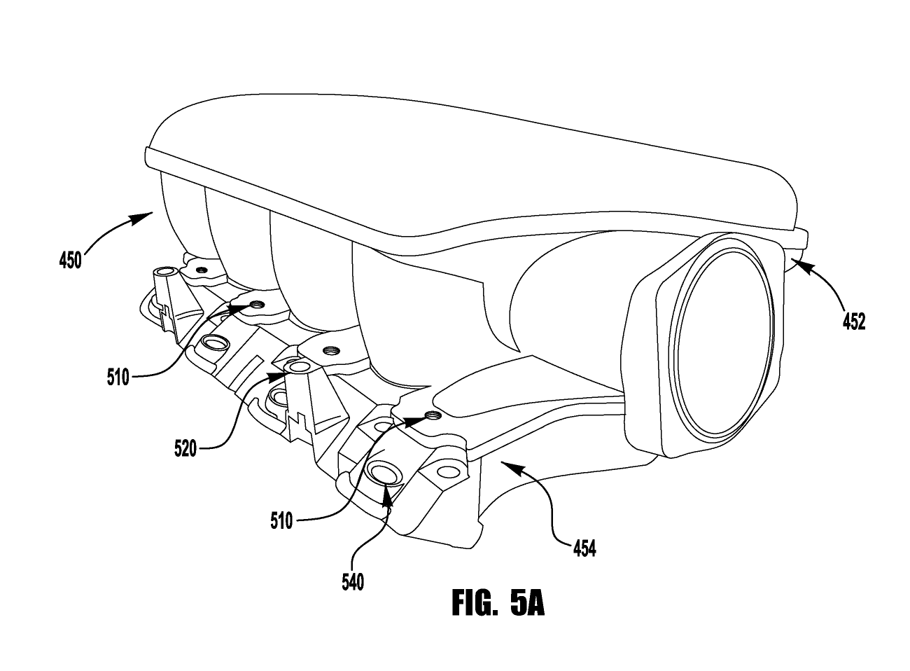

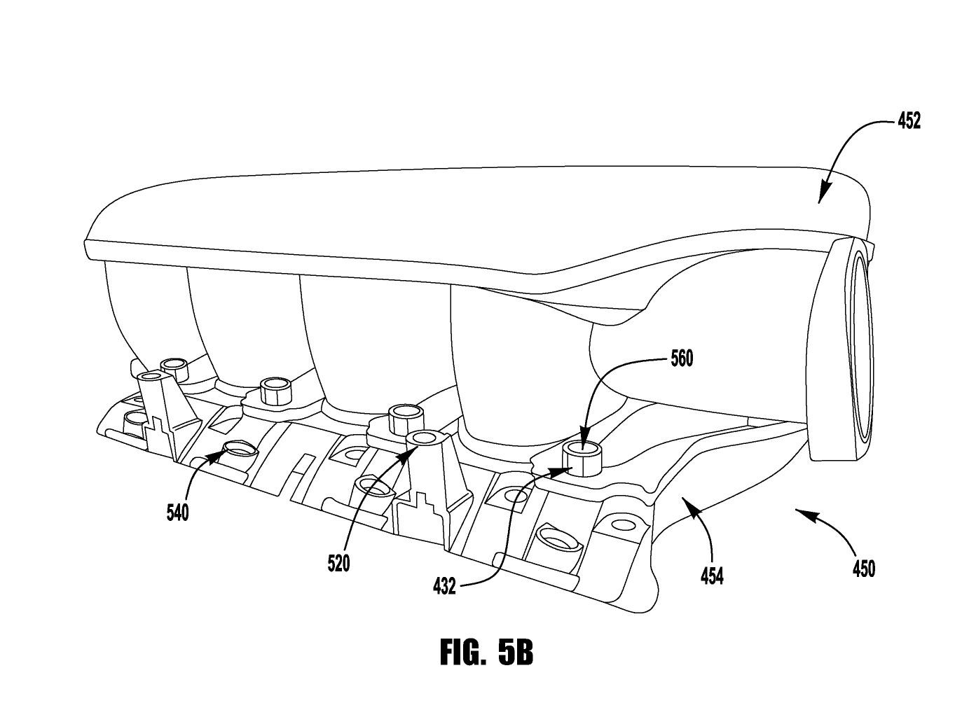

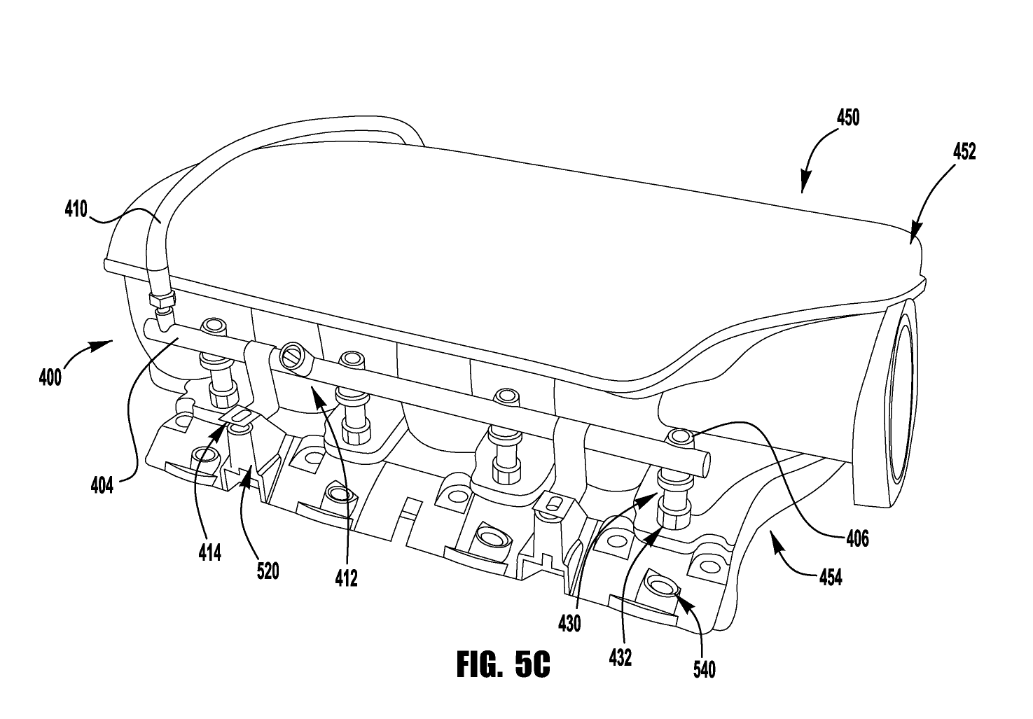

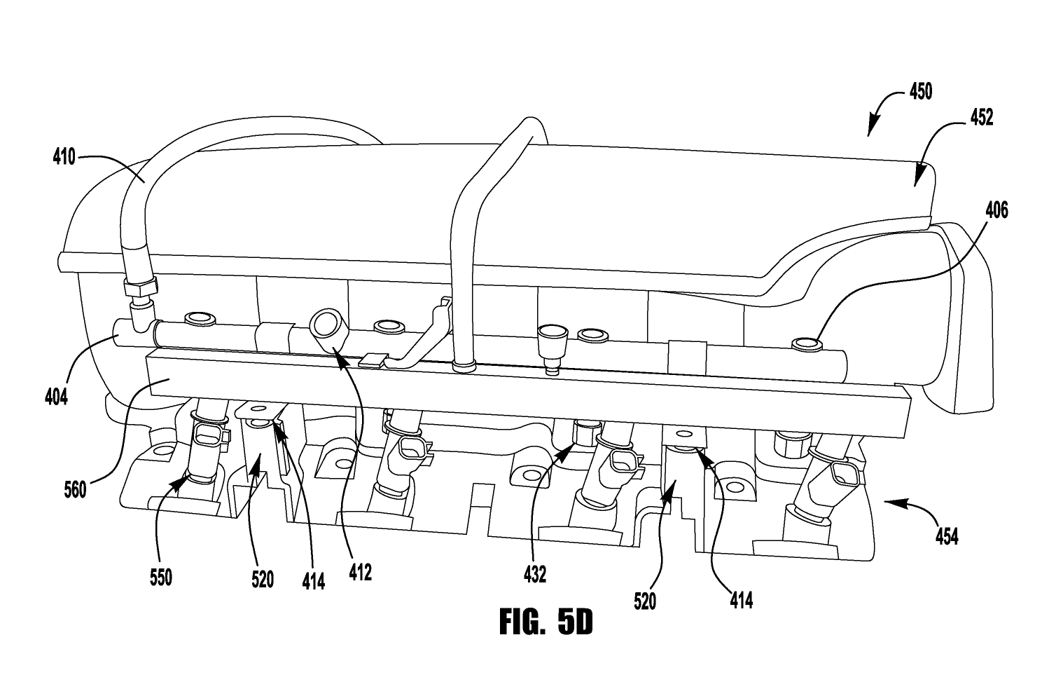

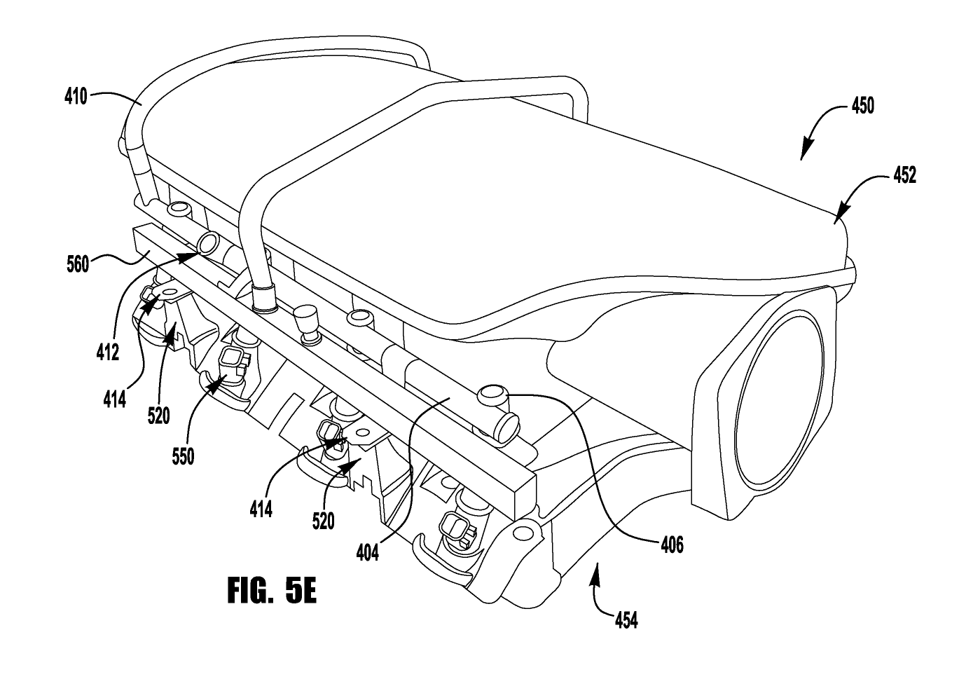

FIGS. 5A-5E illustrate an exemplary method of installing the fuel system 400 on the intake manifold 450 of the engine and converting the engine to operate using a second fuel, such as CNG. As shown in FIG. 5A, holes 510 are drilled and tapped in the lower intake manifold 454 for the fuel injector adapters 432. The holes 510 extend through the lower intake manifold 454 and fluidly communicate with the intake port of the engine. In certain embodiments, at least a portion of the intake manifold 450 of the engine is removed from the vehicle and the original fuel rails and fuel injectors are removed from the engine. At least a portion of the intake manifold 450 is then placed in a machine, such as a CNC or milling machine, that may be pre-programmed to drill and tap the holes 510 in the lower intake manifold 454 for the fuel injector adapters 432. The holes 510 extend through the lower intake manifold 454 and communicate with the intake port of the engine when the intake manifold 450 is re-installed in the vehicle. In other embodiments, the holes 510 are drilled and tapped in the lower intake manifold 454 of the engine without removing the lower intake manifold and/or the original fuel rails and fuel injectors from the engine.

As shown in FIG. 5A, four holes 510 are drilled on each side of the lower intake manifold 454, each hole corresponding to a cylinder of the 8 cylinder engine. The diameter of the holes 510 is generally between about 0.25 inch and about 0.5 inch. In certain embodiments, the diameter of the hole 510 is about 0.4 inch.

As illustrated in FIG. 5B, a fuel injector adapter 432 of the fuel system 400 is inserted into each of the holes 510 drilled in the lower intake manifold 454. As illustrated in FIG. 4B, each fuel injector adapter 432 comprises a threaded stem 480 configured to mate with a corresponding hole 510 in the lower intake manifold 454 to form a substantially fluid tight connection between the adapter and the lower intake manifold.

As shown in FIGS. 4A, 4B, and 5B, each fuel injector adapter 432 comprises a cup shaped portion having a fuel injector opening 560 configured to receive the discharge end of a fuel injector 430 of the fuel system 400. In certain embodiments, the fuel injectors 430 are alternative fuel injectors such as a CNG injectors. However, the fuel injector opening 560 may be configured to receive various types of fuel injectors. Further, the fuel injector opening 560 is sized and configured to form a substantially fluid tight connection between the discharge end of the fuel injector 430 and the adapter 432. A seal, such as a molded rubber gasket, may be used to seal the connection between the fuel injector opening 560 of the adapter 432 and the fuel injector 430. Other methods may be used to seal the adapter 432 with the fuel injector 430, such as, for example, by using room temperature vulcanized (RTV) rubber, organic paper gaskets, or ferrous gasket materials.

As shown in FIGS. 4A and 4B, an injector channel 434 extends between the injector opening 560 of the adapter 432 and an outlet in the threaded stem 480 of the adapter. Fuel discharged from the fuel injector 430 is directed through the channel 434 of the fuel injector adapter 432 and into the intake port of the engine. Further, the fuel injector adapters 432 are configured such that the fuel injectors 430 are positioned to be connected to the fuel injector connectors 406. For example, FIG. 5C shows the fuel injectors 430 installed in the fuel injector adapters 432 and connected to the fuel injector connectors 406 of the first and second fuel rails 402 and 404. As shown, the fuel injector adapters 432 position the fuel injectors 430 substantially upright (i.e., the longitudinal axis of the fuel injector is substantially parallel to the longitudinal axis of the fuel injector adapter) to be connected to the fuel injector connectors 406. In certain embodiments, the fuel injector adapters 432 may be configured to position the fuel injectors 430 at an angle relative to the adapter. For example, one or more of the fuel injector adapters 432 may be configured such that the angle between the longitudinal axis of the fuel injector 430 and the longitudinal axis of the adapter is between 0° and 90°, 0° and 45°, 0° and 30°, or any other angle needed to connect the fuel injector to the fuel injector connector 406.

As shown in FIG. 5C, the fuel injectors 430 are connected to the fuel injector connectors 406 of the first and second fuel rails 402 and 404 of the fuel system 400. The fuel injectors 430 are placed in the fuel injector adapters 432 and the first and second fuel rails 402 and 404 are installed on opposing sides of the intake manifold 450. The flexibility of the fuel line 410 facilitates installation of the rigid fuel rails 402 and 404 and alignment of the fuel injectors 430 in the fuel injector adapters 432. The brackets 414 are used to secure the first and second fuel rails 402 and 404 to the intake manifold 450 and hold the fuel injectors 430 within the fuel injector adapters 432. As shown, the brackets 414 are mounted to mounting portions 520 of the intake manifold 450 with fasteners at the same location as the original fuel rails. However, in certain embodiments, the first and second fuel rails 402 and 404 may be secured to the intake manifold 450 at other locations different than the original fuel rails.

As shown in FIGS. 5D and 5E, the original fuel rails 560 and fuel injectors 550 are re-installed on the intake manifold 450 of the engine. The original fuel injectors 550 are inserted into the original fuel injector openings 540 (FIGS. 5B and 5C) in the lower intake manifold 454 and the original fuel rails 560 are mounted to the intake manifold 450 at the same location as the brackets 414 of the fuel system 400. As shown, the original fuel rails 560 and fuel injectors 550 remain in their original location after the fuel system 400 is installed and the engine is converted to operate using the second fuel. Further, because the fuel system 400 facilitates conversion of the engine to operate using a second fuel without removal of the original fuel rails 560 or fuel injectors 550 (e.g., the gasoline fuel injectors) of the engine, the engine may be configured to selectively operate using the original fuel (e.g., gasoline) and/or the second fuel (e.g., CNG).

The intake manifold 450 is re-installed on the engine of the vehicle. A second fuel source (e.g., a CNG fuel tank) is connected to the first fuel rail 402 at the fuel connection point 408 and the fuel injectors 430 are connected to the electrical system of the vehicle. Similarly, the original fuel rail 560 is connected to the original fuel source (e.g., gasoline tank of the vehicle) and the original fuel injectors 550 are connected to the electrical system of the vehicle.

In certain embodiments, the installation of the fuel system 400 and conversion of an engine to operate using a second fuel may be completed in 45 minutes or less. Further, the conversion time for a vehicle may be decreased by removing the intake manifold of a first engine and replacing it with a previously converted intake manifold. The intake manifold from the first engine may then be converted and used to replace the intake manifold of a second engine. This process is especially beneficial when converting a fleet of vehicles having the same engine or intake manifold because it decreases the amount of time spent converting the fleet to operate using a second fuel. It also decreases the time the vehicle must be out of service during the conversion process.

As described herein, when one or more components are described as being connected, joined, affixed, coupled, attached, or otherwise interconnected, such interconnection may be direct as between the components or may be in direct such as through the use of one or more intermediary components. Also as described herein, reference to a “member,” “component,” or “portion” shall not be limited to a single structural member, component, or element but can include an assembly of components, members or elements.

While the present invention has been illustrated by the description of embodiments thereof, and while the embodiments have been described in considerable detail, it is not the intention of the applicants to restrict or in any way limit the scope of the invention to such details. Additional advantages and modifications will readily appear to those skilled in the art. For example, where components are releasably or removably connected or attached together, any type of releasable connection may be suitable including for example, locking connections, fastened connections, tongue and groove connections, etc. Still further, component geometries, shapes, and dimensions can be modified without changing the overall role or function of the components. The fuel system of the present application may be configured with more or less fuel rails, fuel lines, fuel injectors, fuel injector connectors, or fuel injector adapters. For example, the fuel system of the present application may include four, eight, ten, or twelve fuel injectors, fuel injector connectors, or fuel injector adapters. Therefore, the inventive concept, in its broader aspects, is not limited to the specific details, the representative apparatus, and illustrative examples shown and described. Accordingly, departures may be made from such details without departing from the spirit or scope of the applicant's general inventive concept.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, devices and components, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

We claim:

1. A fuel system for an engine configured to operate using a second fuel, the fuel system comprising:
at least one fuel rail for the second fuel;
at least one connector attached to the fuel rail and configured to fluidly connect the fuel rail to a second fuel injector; and
at least one fuel injector adapter configured to receive a discharge end of the second fuel injector and position the discharge end in fluid communication with at least one of an intake port and a combustion chamber of the engine; and
wherein the fuel system is configured such that the engine operates using the second fuel without removal of the original fuel rails and the original fuel injectors of the engine.

2. The fuel system of claim 1, wherein the fuel system is configured such that the engine operates using the second fuel without use of the original fuel rails and original fuel injectors of the engine.

3. The fuel system of claim 1, wherein the original fuel rails and the original fuel injectors remain in their original location after the fuel system is installed on the engine.

4. The fuel system of claim 1, wherein the fuel system is configured such that the engine can selectively operate using the original fuel and the second fuel.

5. The fuel system of claim 4, wherein the second fuel is compressed natural gas and the original fuel is at least one of gasoline and diesel fuel.

6. The fuel system of claim 1, where the fuel system comprises first and second fuel rails for the second fuel, a fuel line connecting the first and second fuel rails, a plurality of connectors attached to the first and second fuel rails, and a plurality of fuel injector adapters.

7. The fuel system of claim 6, wherein the first and second fuel rails are cylindrical members having a circular cross section substantially along the entire length of the member, and wherein the interior diameter of the cylindrical member is between about ¼ inch and about ½ inch and the overall length of the cylindrical member is between about 12 inches and about 25 inches.

8. The fuel system of claim 6, wherein each fuel rail comprises a plurality of openings spaced along the length of the rail, and wherein each opening is configured to mate with a corresponding opening in a connector, and wherein the openings in each fuel rail and the corresponding openings in the connectors are sized and configured to prohibit turbulent flow of the second fuel to the second fuel injectors.

9. The fuel system of claim 8, wherein the longitudinal axes of the connectors are substantially perpendicular to the longitudinal axes of the first and second fuel rails.

10. The fuel system of claim 8, wherein the fuel rails and the connectors are stainless steel and brazed together to form a rigid and fluid tight structure.

11. The fuel system of claim 6, wherein each connector comprises a cup shaped body portion having an open end for removably attaching the connector to a second fuel injector, and wherein the open end is sized and configured to receive the second fuel injector such that the connector snaps onto the second fuel injector, and wherein the connection between the connector and the second fuel injector is substantially fluid tight.

12. The fuel system of claim 6, wherein the fuel line is flexible to facilitate installation of the first and second fuel rails on opposite sides of the engine, and wherein the fuel line is sized and configured to extend over the upper intake manifold of the engine.

13. The fuel system of claim 6, wherein each fuel injector adapter comprises a cup shaped portion having a fuel injector opening, a threaded stem for attaching the fuel injector adapter to the engine, and an injector channel extending from the fuel injector opening to an outlet in the threaded stem, and wherein each fuel injector adapter is configured such that the second fuel from the discharge end of the second fuel injector is directed through the injector channel to at least one of the intake port and combustion chamber of the engine.

14. The fuel system of claim 13, wherein the fuel injector adapters are configured to position the second fuel injectors substantially upright to be connected to the connectors.

15. A method of converting an engine to operate using a second fuel, comprising the steps of:
drilling and tapping at least one hole in a lower intake manifold of the engine, wherein the hole extends through the lower intake manifold and fluidly communicates with at least one of an intake port and a combustion chamber of the engine;
installing a fuel injector adapter in the hole, wherein the fuel injector adapter comprises a threaded stem configured to mate with the hole;
inserting a second fuel injector into the fuel injector adapter, wherein the discharge end of the second fuel injector is inserted into a fuel injector opening of the fuel injector adapter;
connecting the second fuel injector to a fuel rail, wherein the fuel rail comprises a connector having a cup shaped body portion with an open end for removably attaching the connector to the second fuel injector;
securing the fuel rail to the engine; and
installing the original fuel rails and the original fuel injectors in their original location on the intake manifold of the engine.

16. The method of claim 15 further comprising removing the intake manifold of the engine from the vehicle and removing the original fuel rails and original fuel injectors from the engine.

17. The method of claim 16, wherein the step of drilling and tapping at least one hole in the lower intake manifold of the engine includes placing the intake manifold into a machine that is pre-programmed to drill and tap the hole.

18. The method of claim 15, wherein a plurality of second fuel injectors are connected to first and second fuel rails, and wherein the first and second fuel rails are fluidly connected by a flexible fuel line, and wherein the flexible fuel line facilitates installation of the first and second fuel rails and alignment of the second fuel injectors in a plurality of corresponding fuel injector adapters, and further comprising installing the first and second fuel rails on opposite sides of the intake manifold of the engine.

19. The method of claim 15 further comprising connecting a second fuel source to the fuel rail, connecting the second fuel injector to the electrical system of the vehicle, connecting an original fuel source to the original fuel rails, and connecting the original fuel injectors to the electrical system of the vehicle.

20. A fuel system for an engine, comprising:
first and second fuel rails for a second fuel, wherein each fuel rail comprises a plurality of fuel rail openings spaced along the length of the rail;
a fuel line connecting the first and second fuel rails, wherein the fuel line is flexible to facilitate installation of the first and second fuel rails on opposite sides of the engine, and wherein the fuel line is sized and configured to extend over the upper intake manifold of the engine;
a plurality of connectors attached to the first and second fuel rails, each connector configured to fluidly connect the fuel rail to a second fuel injector, and wherein each connector comprises a connector opening configured to mate with a fuel rail opening, and wherein the fuel rail and connector openings are sized and configured to prohibit turbulent flow of the second fuel to the second fuel injectors; and
a plurality of fuel injector adapters, each fuel injector adapter configured to receive a discharge end of a second fuel injector and position the discharge end in fluid communication with at least one of an intake port and a combustion chamber of the engine, wherein each fuel injector adapter comprises a cup shaped portion having a fuel injector opening, a threaded stem for attaching the fuel injector adapter to the engine, and an injector channel extending from the fuel injector opening to an outlet in the threaded stem, and wherein each fuel injector adapter is configured such that the second fuel from the discharge end of the second fuel injector is directed through the injector channel to at least one of the intake port and combustion chamber of the engine; and
wherein the fuel system is configured such that the engine operates using the second fuel without removal of the original fuel rails and the original fuel injectors of the engine and without use of the original fuel rails and original fuel injectors of the engine, and wherein the original fuel rails and the original fuel injectors remain in their original location after the fuel system is installed on the engine.

21. An engine configured to operate using a second fuel, the engine comprising:
an intake manifold, original fuel rails, and a plurality of original fuel injectors fluidly connected to the original fuel rails to deliver an original fuel to the engine;
first and second fuel rails for a second fuel;
a fuel line connecting the first and second fuel rails;
a plurality of second fuel injectors fluidly connected to the first and second fuel rails to deliver a second fuel to the engine;
a plurality of connectors attached to the first and second fuel rails, each connector configured to fluidly connect the fuel rail to a second fuel injector; and
a plurality of fuel injector adapters, each fuel injector adapter configured to receive a discharge end of a second fuel injector and position the discharge end in fluid communication with at least one of an intake port and a combustion chamber of the engine; and
wherein the engine operates using the second fuel without removal of the original fuel rails and the original fuel injectors and without use of the original fuel rails and original fuel injectors, and wherein the original fuel rails and the original fuel injectors remain in their original location after the first and second fuel rails, second fuel injectors, connectors, and fuel injector adapters are installed on the engine.
